(19) United States
(12) Patent Application Publication
(10) Pub. No.: US 2009/0282649 A1
(43) Pub. Date: Nov. 19, 2009

(54) Hinge

(75) Inventor: Po-Chuan Chen, Shulin City (TW)

Correspondence Address: JACKSON WALKER, L.L.P., 112 E. PECAN, SUITE 2400, SAN ANTONIO, TX, 78205, US

(73) Assignee: Shin Zu Shing Precision Electron (Suzhou) Co., Ltd.

(21) Appl. No.: 12/152,541

(22) Filed: May 15, 2008

(51) Int. Cl. E05D 11/10

(52) U.S. Cl. 16/347; 16/343

(57) ABSTRACT

A hinge has a pintle, a stationary leaf, a first limiting washer, a first positioning washer and a second positioning washer. The stationary leaf is mounted rotatably around the pintle. The first limiting washer is mounted securely on the pintle adjacent to the stationary leaf and has a limit. The first positioning washer is mounted around the pintle, is connected securely to the stationary leaf and has a protrusion and a detent. The protrusion corresponds to and selectively abuts the limit of the first limiting washer. The second positioning washer is mounted securely on the pintle and has a detent being selectively attached to the detent of the first positioning washer. The rotating angle of the pintle relative to the stationary leaf is limited by the limit of the first limiting washer abutting the protrusion of the first positioning washer.

### BACKGROUND OF THE INVENTION

1. Field of the Invention

The present invention relates to a hinge, especially to a hinge being mounted between a cover and a base of an electronic device so as to limit a pivoting angle of the cover to the base.

2. Description of the Prior Arts

Electronic devices such as notebook computers, cell phones and the like have a cover with a display and a base. To allow the cover to be pivoted relative to the base, a hinge is mounted between the cover and the base.

To limit a pivoting angle of the cover to the base, a hinge is designed having a pintle, a moving leaf, a limiting washer and a stationary leaf to limit the pivoting angle. The limiting washer has a limit and the stationary leaf has a stop corresponding to and selectively abutting the limit to limit the pivoting angle of the cover.

However, since the pivoting angle is just limited by the limit and stop, when too much force is applied, the limit may be broken, damaged or passed over by the stop. Therefore, to increase strength of the limit, an additional a limiting washer corresponding to the stationary leaf is required. Thus a longer pintle is required; however, this increases a size of the hinge and prevents the electronic device from being further miniaturized. Furthermore, other components in the hinge need to be modified accordingly, which results in increased complexity in assembly of the hinge so raises costs and increases rejections.

To overcome the shortcomings, the present invention provides a hinge to mitigate or obviate the aforementioned problems.

### SUMMARY OF THE INVENTION

The main objective of the present invention is to provide a hinge with improved strength in limiting a cover of an electronic device pivoting relative to a base of the electronic device without using an additional combination of a limiting washer and a stationary leaf.

The hinge is mounted between the cover and the base of the electronic device and has a pintle, a stationary leaf, a first limiting washer, a first positioning washer, a second positioning washer and a washer assembly.

The pintle has a proximal end and a distal end. The stationary leaf is mounted rotatably around the pintle and has an inner surface and an outer surface.

The first limiting washer is mounted securely on the pintle adjacent to the outer surface of the stationary leaf and has an annular edge and a limit. The limit is formed on and protrudes transversely from the annular edge of the first limiting washer.

The first positioning washer is mounted around the pintle, is connected securely to the stationary leaf adjacent to the outer surface of the stationary leaf and has an inner surface, an outer surface, an annular edge, a protrusion and a positioning portion. The inner surface is adjacent to the first limiting washer. The outer surface is opposite to the inner surface. The protrusion is formed on and protrudes out the inner surface of the first positioning washer, radially extends inwards from the annular edge of the first positioning washer, corresponds to and selectively abuts the limit of the first limiting washer. The detent is mounted on the outer surface of the first positioning washer.

The second positioning washer is mounted securely on the pintle and has an inner surface, an outer surface and a detent. The inner surface faces the outer surface of the first positioning washer. The outer surface is opposite to the inner surface. The detent is formed on the inner surface and selectively engages the detent of the first positioning washer.

The washer assembly is mounted around the pintle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an enlarged, exploded perspective view of the hinge in FIG. 1;

FIG. 3 is another enlarged, exploded perspective view of the hinge in FIG. 1;

FIG. 4 is an exploded perspective view of a first limiting washer and a first positioning washer of the hinge in FIG. 1; and

FIG. 5 is an operational end view in partial section of the hinge in FIG. 1 shown open.

### DETAILED DESCRIPTION OF THE PREFERRED EMBODIMENTS

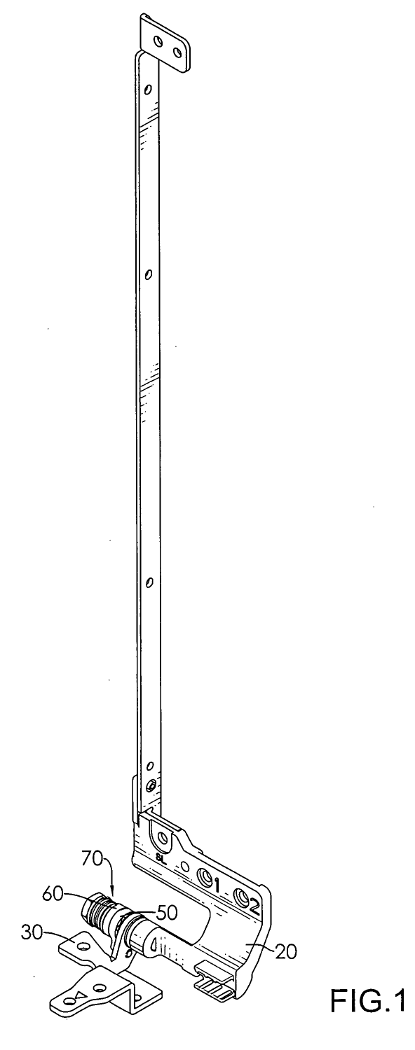

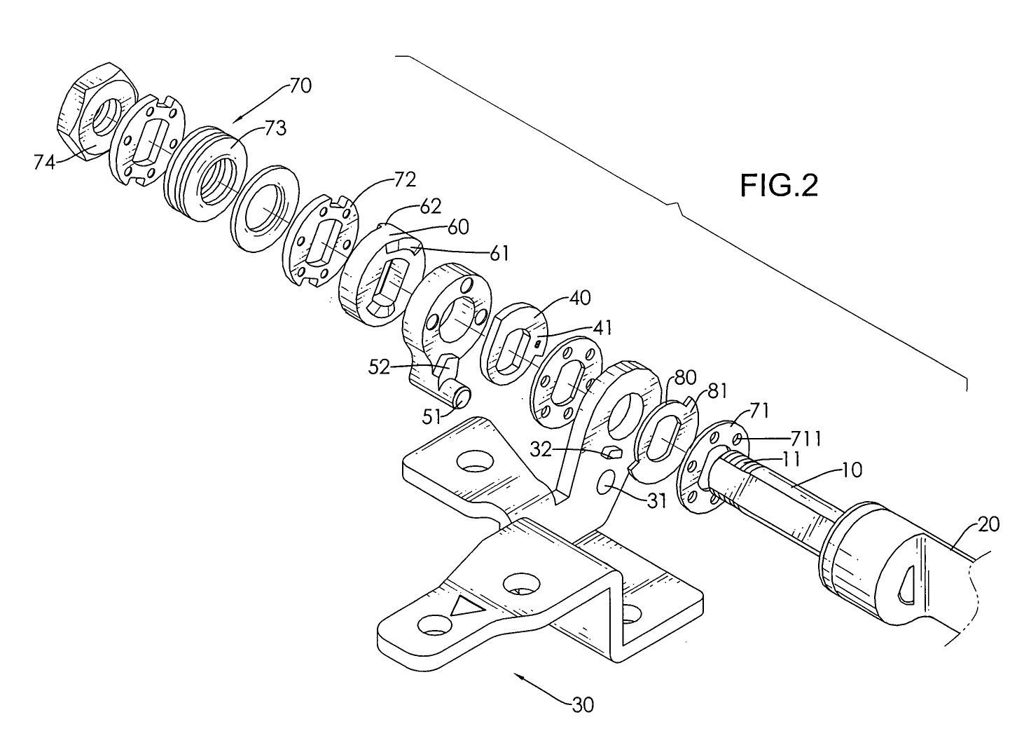

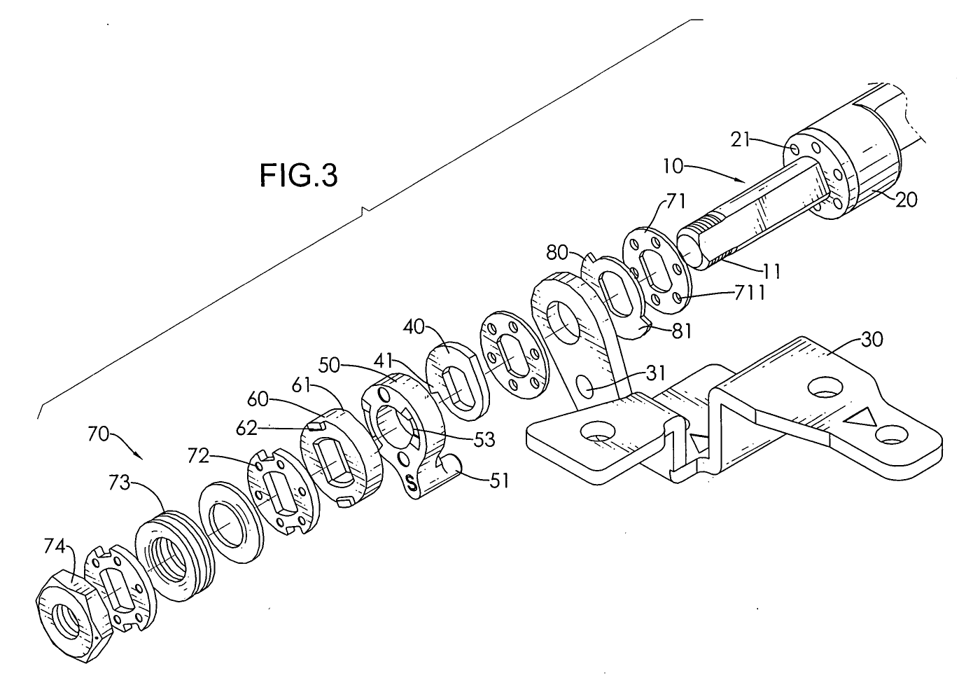

With reference to FIGS. 1, 2 and 3, a hinge in accordance with the present invention comprises a pintle (10), an optional moving leaf (20), a stationary leaf (30), a first limiting washer (40), a first positioning washer (50), a second positioning washer (60), a washer assembly (70) and an optional second limiting washer (80).

The pintle (10) is non-circular in cross section and has a proximal end, a distal end and an optional threaded segment (11). The threaded segment (11) is formed around the distal end of the pintle (10).

The moving leaf (20) is attached securely to the proximal end of the pintle (10) and has a surface and multiple bulges (21). The surface projects radially out from the pintle (10). The bulges are formed on and protrude from the surface and around the pintle (10).

The stationary leaf (30) is mounted rotatably around the pintle (10) and has an inner surface, an outer surface, an optional aperture (31) and an optional stop (32). The aperture (31) is formed through the stationary leaf (30) from the inner surface to the outer surface. The stop (32) is formed on and protrudes from the inner surface of the stationary leaf (30).

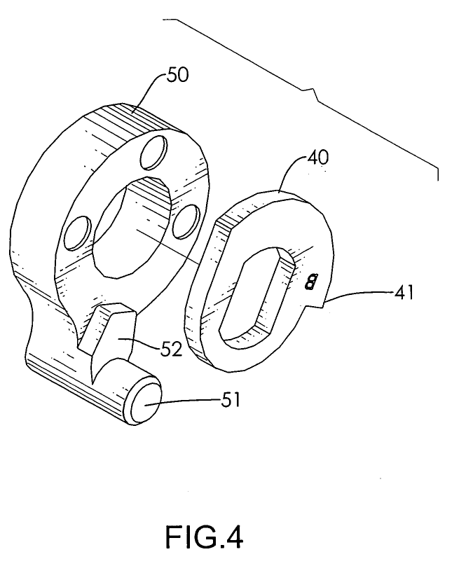

With further reference to FIG. 4, the first limiting washer (40) is mounted securely on the pintle (10) adjacent to the outer surface of the stationary leaf (30) and has an annular edge, a limit (41) and an optional through hole. The limit (41) is formed on and protrudes transversely out from the annular edge of the first limiting washer (41). The through hole is formed centrally through the first limiting washer (40), is non-circular in cross section, corresponds to and passed by the pintle (10).The first positioning washer (50) is mounted rotatably around the pintle (10), is connected securely to the stationary leaf (20) adjacent to the outer surface of the stationary leaf (20) and has an inner surface, an outer surface, an annular edge, an optional post (51), a protrusion (52) and a detent (53). The inner surface is adjacent to the first limiting washer (40). The outer surface is opposite to the inner surface. The post (51) is formed on and protrudes from the inner surface of the first positioning washer (50) and is mounted through the aperture (31) of the stationary leaf (30). The protrusion (52) is formed on and protrudes from the inner surface of the first positioning washer (50) and radially extends inwards from the annular edge of the first positioning washer (50), may be adjacent to the post (51), corresponds to and selectively abuts the limit (41) of the first limiting washer (40) to limit a pivoting angle of the pintle (10). The detent (53) is formed on the outer surface of the first positioning washer (50) and may be recessed.

The second positioning washer (60) is mounted securely on the pintle (10) and has an inner surface, an outer surface, a detent (61) and at least one optional boss (62). The inner surface faces the outer surface of the first positioning washer (50). The outer surface is opposite to the inner surface. The detent (61) of the second positioning washer (60) is formed on the inner surface of the second positioning washer (60), corresponds to and selectively engages the detent (53) of the first positioning washer (50) to provide preferred preset positions and may be protrudent. The at least one boss (62) is formed on the outer surface of the second positioning washer (60).

The washer assembly (70) is mounted around the pintle (10) and has an optional abrasion washer (71), an optional integrating washer (72), a biasing member (73) and an optional fastener (74). The abrasion washer (71) is mounted securely around the pintle (10) to reduce abrasion between washers and has an inner surface, an outer surface, multiple notches (711) and an optional through hole. The outer surface faces the stationary leaf (30) and is opposite to the inner surface. The notches are formed on the inner surface of the abrasion washer (71) and respectively correspond to and engage the bulges of the moving leaf (20) to provide preferred preset positions. The through hole of the abrasion washer (71) is formed centrally through the abrasion washer (71), is non-circular, corresponds to and is mounted around the pintle (10). The integrating washer (72) is mounted securely around the pintle (10) and has an edge and multiple grooves. The grooves are respectively formed in the edge of the integrating washer (72) and correspond to and engage the bosses (62) of the second positioning washer (60) to provide an additional retention force for the second positioning washer (60) to ensure secure mounting on the pintle (10). The biasing member (73) is mounted around the pintle (10) to provide a resistive force. The fastener (74) is mounted securely on the distal end of the pintle (10) and may be a nut engaging the threaded segment (11) of the pintle (10).

The second limiting washer (80) is mounted securely on the pintle (10) adjacent to the stationary leaf (30) and may be between the moving leaf (20) and the abrasion washer (71) and has an annular edge and a limit (81). The limit (81) is formed on and protrudes transversely from the annular edge of the second limiting washer (80) and corresponds to and selectively abuts the stop (32) on the stationary leaf (30) to limit the rotating angle of the pintle (10).

The hinge as described is mounted between a cover and a base of an electronic device. The pintle (10) or the moving leaf (20) is connected to the cover. The stationary leaf (30) is connected to the base. When the cover is pivoted relative to the base, the pintle (10) is rotated relative to the stationary leaf (30). The first limiting washer (40), the second limiting washer (80), the second positioning washer (71) and the integrating washer (72) of the washer assembly (70), are rotated relative to the stationary leaf (30).

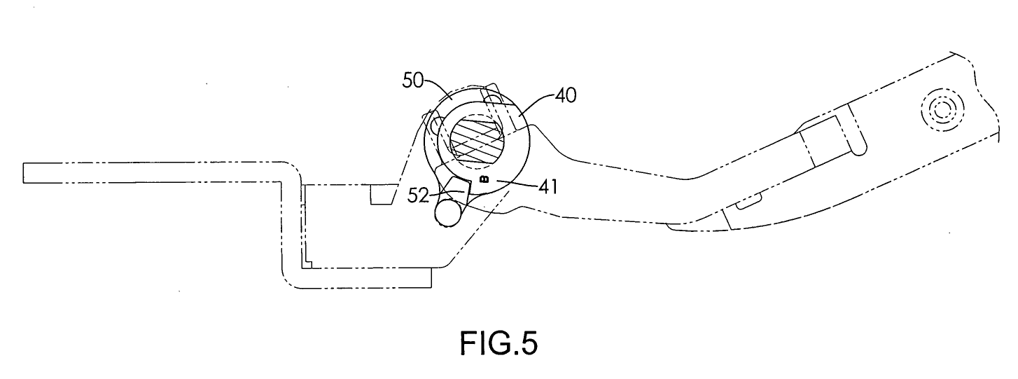

With further reference to FIG. 5, the limit (41) of the first limiting washer (40) abuts the protrusion (52) of the first positioning washer (50) to limit the rotating angle of the pintle (10). The limit (81) of the second limiting washer (80) abuts the stop (32) of the stationary leaf (30) to further provide an improved strength to limit the rotation of the pintle (10). Since the first positioning washer (50) not only provides preferred preset positions but also increases friction, of pivoting the pintle (10) so ensures pivoting angle of the hinge is limited effectively. Furthermore, the abrasion washer (71) of the hinge can also provide the pintle (10) preferred preset positions and improved friction.

By contrast, the conventional hinge needs an additional combination of a limiting washer and a stationary leaf to increase a strength to limit the pivoting angle of the pintle (10). Conversely, the hinge in accordance with the present invention has increased strength without increasing length of the pintle (10). Therefore, the hinge is especially suitable for an electronic device, especially small electronic devices. Further, no other components in the hinge need to be modified, which results in simplifying the assembly of the hinge.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a pintle having
a proximal end; and
a distal end;
a stationary leaf being mounted rotatably around the pintle and having
an inner surface; and
an outer surface;
a first limiting washer being mounted securely on the pintle adjacent to the outer surface of the stationary leaf and having
an annular edge; and
a limit being formed on and protruding transversely out from the annular edge of the first limiting washer;
a first positioning washer being mounted rotatably around the pintle, being connected securely to the stationary leaf adjacent to the outer surface of the stationary leaf and having
an inner surface being adjacent to the first limiting washer;
an outer surface being opposite to the inner surface;
an annular edge;
a protrusion being formed on and protruding from the inner surface of the first positioning washer, radially extending inwards from the annular edge of the first positioning washer, corresponding to and selectively abutting the limit of the first limiting washer; and
a detent being formed on the outer surface of the first positioning washer;
a second positioning washer being mounted securely on the pintle and having
an inner surface facing the outer surface of the first positioning washer;
an outer surface being opposite to the inner surface; and
a detent being formed on the inner surface of the second positioning washer and selectively engaging the detent of the first positioning washer; and
a washer assembly being mounted around the pintle and having a biasing member being mounted around the pintle.

2. The hinge as claimed in claim 1 further comprising
a second limiting washer being mounted securely on the pintle adjacent to the stationary leaf and having
an annular edge; and
a limit being formed on and protruding transversely from the annular edge of the second limiting washer; and
the stationary leaf further has a stop being formed on and protruding from the inner surface of the stationary leaf and corresponding to and selectively abutting the limit of the second limiting washer.

3. The hinge as claimed in claim 2, wherein
the stationary leaf further has an aperture being formed through the stationary leaf from the inner surface to the outer surface; and
the first positioning washer further has a post being formed on and protruding from the inner surface of the first positioning washer and being mounted through the aperture of the stationary leaf.

4. The hinge as claimed in claim 1 further comprising a moving leaf being attached securely to the proximal end of the pintle

5. The hinge as claimed in claim 2 further comprising a moving leaf being attached securely to the proximal end of the pintle

6. The hinge as claimed in claim 3 further comprising a moving leaf being attached securely to the proximal end of the pintle

7. The hinge as claimed in claim 4, wherein
the moving leaf further has
a surface projecting radially out from the pintle; and
multiple bulges being formed on and protruding from the surface and around the pintle; and
the washer assembly further has a abrasion washer being mounted securely around the pintle and having
an inner surface;
an outer surface facing the stationary leaf and being opposite to the inner surface; and
multiple notches being formed on the inner surface of the abrasion washer and respectively corresponding to and engaging the bulges of the moving leaf.

8. The hinge as claimed in claim 5, wherein
the moving leaf further has
a surface projecting radially out from the pintle; and
multiple bulges being formed on the surface and around the pintle; and
the washer assembly further has a abrasion washer being mounted securely around the pintle and having
an inner surface;
an outer surface facing the stationary leaf and being opposite to the inner surface; and
multiple notches being formed on the inner surface of the abrasion washer and respectively corresponding to and engaging the bulges of the moving leaf.

9. The hinge as claimed in claim 6, wherein
the moving leaf further has
an edge projecting radially out from the pintle; and
multiple bulges being formed on the edge and around the pintle; and
the washer assembly further has a abrasion washer being mounted securely around the pintle and having
an inner surface;
an outer surface facing the stationary leaf and being opposite to the inner surface; and
multiple notches being formed on the inner surface of the abrasion washer and respectively corresponding to and engaging the bulges of the moving leaf.

10. The hinge as claimed in claim 7, wherein the detent of the first positioning washer is recessed; and
the detent of the second positioning washer is protrudent.

11. The hinge as claimed in claim 8, wherein the detent of the first positioning washer is recessed; and
the detent of the second positioning washer is protrudent.

12. The hinge as claimed in claim 9, wherein the detent of the first positioning washer is recessed; and
the detent of the second positioning washer is protrudent.

13. The hinge as claimed in claim 10, wherein
the second positioning washer further has
multiple bosses, each boss being formed on the outer surface of the second positioning washer; and
the washer assembly further has
an integrating washer being mounted securely round the pintle and having
an edge; and
multiple grooves being respectively formed in the edge of the integrating washer and corresponding to and engaging the bosses of the second positioning washer.

14. The hinge as claimed in claim 11, wherein
the second positioning washer further has
multiple bosses, each boss being formed on the outer surface of the second positioning washer; and
the washer assembly further has
an integrating washer being mounted securely round the pintle and having
an edge; and
multiple grooves being formed respectively in the edge of the integrating washer and corresponding to and engaging the bosses of the second positioning washer.

15. The hinge as claimed in claim 12, wherein
the second positioning washer further has
multiple bosses, each boss being formed on the outer surface of the second positioning washer; and
the washer assembly further has
an integrating washer being mounted securely round the pintle and having
an edge; and
multiple grooves being respectively formed in the edge and corresponding to and engaging the bosses of the second positioning washer.

16. The hinge as claimed in claim 13, wherein
the pintle is non-circular in cross section; and
the first limiting washer further has a through hole formed centrally through the first limiting washer, being non-circular in cross section, corresponding to and being passed by the pintle; and
the third limiting washer further has a through hole being formed through the third limiting washer, being non-circular in cross section, corresponding to and being passed by the pintle.

17. The hinge as claimed in claim 14, wherein
the pintle is non-circular in cross section; and
the first limiting washer further has a through hole formed centrally through the first limiting washer, being non-circular in cross section, corresponding to and being passed by the pintle; and
the third limiting washer further has a through hole being formed through the third limiting washer, being non-circular in cross section, corresponding to and being passed by the pintle.

18. The hinge as claimed in claim 15, wherein
the pintle is non-circular in cross section; and
the first limiting washer further has a through hole formed centrally through the first limiting washer, being non-circular in cross section, corresponding to and being passed by the pintle; and
the third limiting washer further has a through hole being formed through the third limiting washer, being non-circular in cross section, corresponding to and being passed by the pintle.

19. The hinge as claimed in claim 16, wherein the pintle further has a threaded segment being formed around the distal end of the pintle; and
the washer assembly further has a fastener being mounted securely on the distal end of the pintle and engaging the threaded segment of the pintle.

20. The hinge as claimed in claim 18, wherein the pintle further has a threaded segment being formed around the distal end of the pintle; and
the washer assembly further has a fastener being mounted securely on the distal end of the pintle and engaging the threaded segment of the pintle.
